(19) United States
(12) Patent Application Publication
(10) Pub. No.: US 2025/0191611 A1
(43) Pub. Date: Jun. 12, 2025

(54) METHOD OF PRODUCING MAGNETIC RECORDING MEDIUM

(71) Applicant: Resonac Hard Disk Corporation, Chiba (JP)

(72) Inventors: Shoko UETAKE, Chiba (JP); Koshiro YOSHIYAMA, Chiba (JP); Yoshihiko MARUYAMA, Chiba (JP); Naoya FUKUMOTO, Tokyo (JP); Ayumi YAMAKAWA, Chiba (JP); Kazuki SHINDO, Chiba (JP)

(21) Appl. No.: 18/970,375

(22) Filed: Dec. 5, 2024

(30) Foreign Application Priority Data
Dec. 12, 2023 (JP) 2023-209347
Apr. 25, 2024 (JP) 2024-071899

(51) Int. Cl. G11B 5/725; G11B 5/72; G11B 5/84

(52) U.S. Cl. CPC G11B 5/725; G11B 5/722; G11B 5/8408

(57) ABSTRACT

A method of producing a magnetic recording medium is provided, in which a lubricating layer is formed on a stack including a magnetic recording layer and a protective layer disposed on a substrate in this order. The method includes: coating the stack with first and second lubricants; burnishing a surface of the coated stack with an abrasive material; and removing the second lubricant present on the stack. The first lubricant has a mean molecular weight greater than that of the second lubricant, and molecules of the first lubricant are more polar than molecules of the second lubricant. The burnishing includes pressing a tape including the abrasive material against the surface of the stack to rub the surface of the stack. The removing of the second lubricant includes irradiating the coated stack with ultraviolet rays, or performing a heat treatment on the coated stack.

### CROSS-REFERENCE TO RELATED APPLICATIONS

This application is based upon and claims priority to Japanese Patent Application No. 2023-209347 filed on Dec. 12, 2023, and Japanese Patent Application No. 2024-071899 filed on Apr. 25, 2024, the entire contents of which are incorporated herein by reference.

### BACKGROUND

### 1. Field of the Invention

The present disclosure relates to methods of producing magnetic recording media.

### 2. Description of the Related Art

In recent years, magnetic storage devices have been mounted in various products, such as personal computers, video recorders, data servers, and the like, and importance of magnetic storage devices has increased. The magnetic storage devices are devices including magnetic recording media to which electronic data is stored by magnetic recording. Examples of the magnetic recording media include hard disk drives (HDD) and the like.

A typical magnetic recording medium includes, for example, an underlayer, an intermediate layer, a magnetic recording layer, and a protective layer formed on a non-magnetic substrate in this order, and has a multilayer stack structure in which an exposed surface of the protective layer is coated with a lubricating layer. The protective layer and the lubricating layer are provided for preventing abrasion damage caused by sliding contact between the magnetic recording medium and a magnetic head. As the protective layer, a hard carbon film is typically used. The lubricating layer is formed by applying a fluid perfluoroether compound to the surface of the protective layer.

It has been known that various treatments are performed on the lubricating layer for the purpose of enhancing bonding strength of the lubricating layer to the protective layer. For example, a method in which a heat treatment is performed on an applied lubricating layer, and light irradiation using a ultraviolet (UV) lamp is further performed on the lubricating layer is disclosed in Japanese Laid-Open Patent Publication No. H11-25452.

Moreover, tape burnishing is performed on a surface of a magnetic recording medium using a burnishing tape in order to remove foreign substances or protrusions at a surface of a protective layer. It has been known that tape burnishing is performed after formation of a lubricating layer in order to minimize scratches formed on the protective layer by tape burnishing.

A method of producing a recording medium is disclosed in Japanese Laid-Open Patent Publication No. 2002-222519. In the disclosed method, after forming a protective layer, a first lubricant that does not include a terminal group in the molecular structure is applied onto an exposed surface of the protective layer, tape burnishing is performed, followed by removing the first lubricant, and then a second lubricant including a terminal group in the molecular structure is applied.

### SUMMARY

A method of producing a magnetic recording medium according to the present disclosure is a method of producing a magnetic recording medium in which a lubricating layer is formed on a stack in which a magnetic recording layer and a protective layer are disposed on a substrate in an order as mentioned. The method includes: coating the stack with a first lubricant and a second lubricant; burnishing a surface of the stack, which is coated with first lubricant and the second lubricant, with an abrasive material; and removing the second lubricant present on the stack. The first lubricant has a mean molecular weight that is greater than a mean molecular weight of the second lubricant. Molecules of the first lubricant are more polar than molecules of the second lubricant. The burnishing includes pressing a tape including the abrasive material against the surface of the stack to rub the surface of the stack. The removing of the second lubricant includes irradiating the stack, which is coated with the first lubricant and the second lubricant, with ultraviolet rays, or performing a heat treatment on the stack, which is coated with the first lubricant and the second lubricant.

### BRIEF DESCRIPTION OF THE DRAWINGS

FIG. 1 is a cross-sectional view illustrating one example of a magnetic recording medium produced by the method of producing the magnetic recording medium according to the present disclosure;

FIG. 2 is a view describing one example of a formation method for a lubricating layer;

FIG. 3 is an enlarged cross-sectional view illustrating one example of a tape including an abrasive material, which is used for burnishing; and

FIG. 4 is a view illustrating one example of a burnishing device used for burnishing a surface of the stack with the abrasive material.

### DESCRIPTION OF THE PREFERRED EMBODIMENTS

In production of magnetic recording media, tape burnishing is performed after formation of a lubricating layer. Therefore, scratches on the produced magnetic recording media can be minimized owing to lubricity of the lubricating layer. However, the lubricant used for the lubricating layer or the thickness of the lubricating layer may not be suitable for tape burnishing.

It could be possible to perform processing using a first lubricant suitable for tape burnishing, followed by removing the first lubricant, and then applying a second lubricating layer suitable for a magnetic recording medium, as in the method of producing the magnetic recording medium disclosed in Japanese Laid-Open Patent Publication No. 2002-222519. In this case, there is, however, the following problem. Specifically, contaminants or the lubricant dissolved in the solvent used for removal of the lubricant is deposited back on the processed substrate, which remains as foreign substances at the surface of the magnetic recording medium. Moreover, it is difficult to completely remove the lubricant bonded to the protective layer using the solvent, and the remaining solvent leads to deposition of foreign substances on the surface of the magnetic recording medium. In addition, coverage of the surface of the magnetic recording medium with the lubricating layer is reduced, and the production process of the magnetic recording medium becomes complicated.

The present disclosure has been made considering the above-described circumstances, and aims to provide a method of producing a magnetic recording medium by which foreign substances at a surface of the magnetic recording medium can be efficiently removed, and high coverage with a lubricating layer is achieved.

Hereinafter, embodiments of the present disclosure will be described in detail with reference to the drawings. In order to facilitate understanding of the description, the same components are denoted by the same reference numerals in the drawings, and redundant description is omitted as appropriate. In addition, the scale of each member in the drawings may be different from the actual scale. In the present specification, “to” indicating a numerical range means that numerical values described before and after “to” are included as a lower limit value and an upper limit value, unless otherwise specified.

The method of producing the magnetic recording medium according to the present embodiment of the present disclosure will be described hereinafter. In addition, a magnetic recording medium produced by the method of producing the magnetic recording medium according to the present embodiment will be described hereinafter.

### [Magnetic Recording Medium]

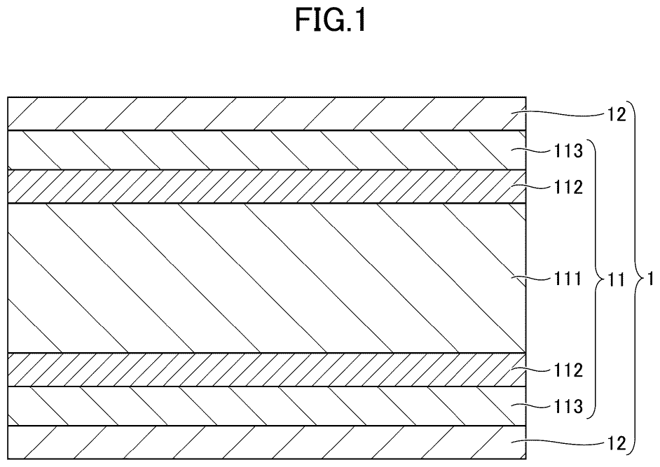

FIG. 1 is a cross-sectional view illustrating one example of a magnetic recording medium produced by the method of producing the magnetic recording medium according to the present embodiment. As illustrated in FIG. 1, the magnetic recording medium 1 includes a lubricating layer 12 on either side of a stack (may be also referred to as a stacked body) 11.

In the present disclosure, the term “stack” encompasses a stack of layers or films that are constituent components of the magnetic recording medium. The stack 11 includes a magnetic recording layer 112 and a protective layer 113 that are disposed on either side of a substrate 111 in this order from the side of the substrate 111.

The substrate 111 is a non-magnetic body. For example, the substrate 111 may be a metal substrate including a metal material, such as an aluminum alloy or the like, or a non-metal substrate including a non-metal material, such as glass, or the like. Moreover, an NiP alloy layer may be formed on the surface of the metal substrate or non-metal substrate, for example, by plating, sputtering, or the like.

The magnetic recording layer 112 is a layer provided for recording and reading information. For example, the magnetic recording layer 112 is a layer in which orientation of magnetization is reversed by magnetic energy supplied from a magnetic head of an HDD and the magnetization state is maintained to store data.

In the magnetic recording layer 112, an L1₀ ordered FePt alloy, an L1₀ ordered CoPt alloy, a CoCrPt alloy, or the like is used.

For formation of the magnetic recording layer 112, a method known in the related art, such as sputtering, ion beam deposition, or the like, can be used.

The protective layer 113 is provided for minimizing corrosion of the magnetic recording layer 112. The protective layer 113 is also provided for protecting the surface of the magnetic recording medium 1 from damage when a magnetic head comes into contact with the magnetic recording medium 1. Further, the protective layer 113 is provided for improving corrosion resistance of the magnetic recording medium 1.

The protective layer 113 can be formed using any material known in the related art. For example, a hard carbon film or diamond-like carbon (DLC) can be used for the protective layer 113.

For formation of the protective layer 113, a method known in the related art, such as sputtering, ion beam deposition, or the like, can be used.

The surface of the protective layer 113 may be hydrogenated or nitrided. As the surface of the protective layer 113 is hydrogenated or nitrided, bonding strength between the surface of the protective layer 113 and the lubricating layer 12 formed on the protective layer 113 can be increased. Specifically, since the first lubricant applied onto the protective layer 113 has the molecular polarity, the molecules of the first lubricant form strong bonds with hydrogen atoms or nitrogen atoms present at the surface of the protective layer 113. In particular, the surface of the protective layer 113 is preferably nitrided.

The lubricating layer 12 is provided for minimizing abrasion of a magnetic head and abrasion of the surface of the magnetic recording medium 1 when the magnetic head comes into contact with the magnetic recording medium 1, and improving corrosion resistance of the magnetic recording medium 1.

The thickness of the lubricating layer 12 is preferably from 0.5 nm to 1 nm (5 Å to 10 Å). The lubricating layer 12 having the thickness of from 0.5 nm to 1 nm (5 Å to 10 Å) can inhibit abrasion of the surface of the magnetic recording medium 1 to thereby improve corrosion resistance of the magnetic recording medium 1.

In addition, a short distance between a magnetic head and the magnetic recording medium 1 is maintained in a HDD, thereby achieving high recording density.

### [Method of Producing Magnetic Recording Medium]

The method of producing the magnetic recording medium according to the present embodiment includes: stacking a magnetic recording layer 112 and a protective layer 113 on either side of a substrate 111 in this order to form a stack 11 (stack formation step); coating the stack 11 with a first lubricant 121 and a second lubricant 122 (coating step); burnishing a surface of the stack 11, which is coated with the first lubricant 121 and the second lubricant 122, with an abrasive material (burnishing step); and removing the second lubricant 122 present on the stack 11 (removing step). The method of producing the magnetic recording medium according to the present embodiment may further include other steps. As other steps, for example, a step of forming an adhesion layer, a soft magnetic under layer, a seed layer, or an orientation control layer between the substrate 111 and the magnetic recording layer 112 may be included. In the case where two or more magnetic recording layers 112 are disposed, the method of producing the magnetic recording medium according to the present embodiment may include a step of forming a non-magnetic recording layer between the magnetic recording layers 112.

In the method of producing a magnetic recording medium according to the present embodiment, first, a magnetic recording layer 112 and a protective layer 113 are disposed on either side of a provided substrate 111 to form a stack 11 (stack formation step).

The stack 11 can be formed by a typical film forming method for the magnetic recording layer 112 and the protective layer 113.

First, the magnetic recording layer 112 is formed on either side of the substrate 111. As a formation method of the magnetic recording layer 112, a typical film formation method, such as sputtering or the like, can be used.

For the sputtering, a target including constituent substances of the magnetic recording layer 112 is used.

As the target including constituent substances of the magnetic recording layer 112, for example, an L1₀ ordered FePt alloy, an L1₀ ordered CoPt alloy, a CoCrPt alloy or the like can be used.

As the sputtering, DC sputtering, DC magnetron sputtering, RF sputtering, or the like can be used.

When the magnetic recording layer 112 is formed, radio frequency (RF) bias, DC bias, pulse DC, pulse DC bias, or the like may be used as appropriate.

As a reactive gas, O₂ gas, H₂O gas, N₂ gas, or the like may be used.

The sputtering gas pressure is appropriately adjusted so that properties of each layer are to be optimal. Typically, the sputtering gas pressure is in the approximate range of from 0.1 Pa to 30 Pa.

Next, a protective layer 113 is formed on the magnetic recording layer 112. A formation method of the protective layer 113 is not particularly limited. For example, a typical film formation method, such as radio frequency-chemical vapor deposition (RF-CVD), ion beam deposition (IBD), filtered cathodic vacuum arc (FCVA), or the like can be used. In RF-CVD, a raw material gas including hydrocarbon is decomposed by a high frequency plasma to deposit a film. In IBD, a raw material gas is ionized by electrons released from a filament to thereby deposit a film. In FCVA, a film is formed using a solid carbon target without using a raw material gas.

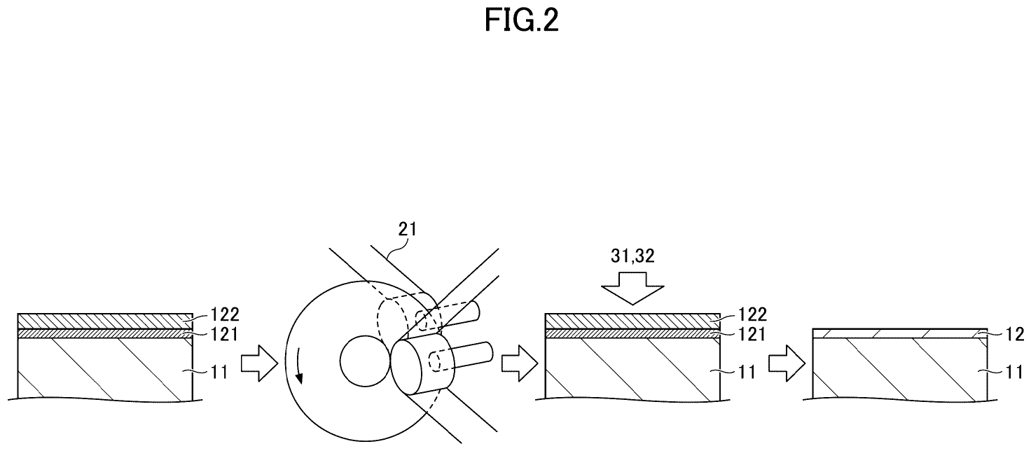

Next, the stack 11 is coated with a first lubricant 121 and a second lubricant 122 (coating step). One example of a formation method of a lubricating layer 12 will be described with reference to FIG. 2.

After coating the stack 11, in which the magnetic recording layer 112 and the protective layer 113 are disposed on either side of the substrate 111 in this order, with a first lubricant 121 and a second lubricant 122, the surface of the stack 11 is burnished with an abrasive material 21. Thereafter, ultraviolet (UV) irradiation 31 or a heat treatment 32 is performed to remove the second lubricant 122 present on the stack 11. Thus, the first lubricant 121 forms the lubricating layer 12 of the magnetic recording medium 1.

Specifically, the second lubricant 122 is removed in the process of performing the UV irradiation 31 or the heat treatment 32 after coating the surface of the stack 11 with the first lubricant 121 and the second lubricant 122. Thus, the first lubricant 121 remains on the surface of the protective layer 113. When the first lubricant 121 is applied onto the protective layer 113, ideally, the entire surface of the protective layer 113 is preferably covered with the first lubricant 121. However, some parts of the surface of the protective layer 113 may not be coated with the first lubricant 121. Such parts may be coated with the second lubricant 122.

In the process of performing the UV irradiation 31 or the heat treatment 32, the second lubricant 122 is preferably completely removed, but some portions of the second lubricant 122 may remain.

In the present embodiment, the UV irradiation 31 or the heat treatment 32 is used for removal of the second lubricant 122. As described above, in the related art, a lubricant used for burnishing has been removed by solvent washing. According to the study conducted by the present inventors, the following has become clear. In addition to the lubricant to be removed, contaminants generated during burnishing are dissolved in the solvent, and the solvent remains on the washed surface for a certain period. Therefore, the contaminants or lubricant may be deposited back on the treated substrate, and the deposited contaminants or lubricant remains as foreign substances at the surface of the magnetic recording medium. In addition, it is difficult to completely remove the lubricant bonded to the protective layer by solvent washing, and a trace of the lubricant remains, which will be left as a foreign substance at the surface of the magnetic recording medium.

In the present embodiment, removal of the second lubricant 122 on the stack 11 is performed by the UV irradiation 31 or the heat treatment 32, i.e., dry processing. The second lubricant 122 or contaminants dissolved in the second lubricant 122 are immediately vaporized and detached from the surface of the stack 11. Therefore, the second lubricant 122 or contaminants dissolved in the second lubricant 122 do not remain as foreign substances at the surface of the magnetic recording medium. In addition, the second lubricant 122 present on the stack 11 can be completely removed by adjusting the conditions of the UV irradiation 31 or the heat treatment 32 so that the second lubricant 122 can be vaporized. Since the above process of formation of the lubricating layer 12 is simple, the method of producing the magnetic recording medium with high productivity can be provided.

The mean molecular weight of the first lubricant 121 is greater than the mean molecular weight of the second lubricant 122, and molecules of the first lubricant 121 is more polar than molecules of the second lubricant 122.

An organic compound used as the lubricant includes one or more functional groups in the molecular structure of the organic compound, such as a hydroxyl group, an amino group, a carbonyl group, a carboxyl group, a cyano group, a phenyl group, a methyl group, and the like. Among such functional groups, a hydroxyl group, an amino group, an amide group, a carbonyl group, a carboxyl group, and a cyano group are examples of the functional groups having the polarity (polar groups).

The mean molecular weight of the first lubricant 121 is preferably from 900 to 3,000, and the number of polar groups included in the structural formula of the first lubricant 121 is preferably from 4 to 8.

The mean molecular weight of the second lubricant 122 is preferably from 300 to 1,000, and the number of polar groups included in the structural formula of the second lubricant 122 is preferably 2 or less. Alternatively, the second lubricant 122 preferably includes no polar group.

A polar group that may be included in the first lubricant 121 or the second lubricant 122 is preferably a hydroxyl group, an amide group, or a cyano group. Among such polar groups, a hydroxyl group is preferably included. Since the first lubricant 121 or the second lubricant 122 includes the above preferred polar group, the first lubricant 121 becomes suitable for the lubricating layer 12 of the magnetic recording medium 1, and the second lubricant 122 makes the surface of the stack 11 suitable for burnishing. In addition, when the above UV irradiation 31 or the heat treatment 32 is performed, immediate removability of the second lubricant 122 or contaminants dissolved in the second lubricant 122 is facilitated. Further, the first lubricant 121 is allowed to remain on the stack 11, and therefore the bonding strength between the protective layer 113 and the first lubricant 121 is enhanced. Thus, foreign substances at the surface of the magnetic recording medium 1 can be further reduced, and the coverage of the magnetic recording medium 1 with the lubricating layer 12 can be increased.

For coating of the first lubricant 121 and the second lubricant 122, a method known in the related art, such as dip coating, spin coating, vapor deposition, or the like, can be used. The dip coating is a method in which, after dipping the stack 11 in a liquid where a lubricant is dissolved, the stack 11 is pulled up at constant speed to form a film of the lubricant on the surface of the stack 11. The spin coating is a method in which, after coating the surface of the stack 11 with a liquid in which a lubricant is dissolved, the stack 11 is rotated at high speed for a certain period to form a film of the lubricant on the stack 11. The vapor deposition is a method in which the stack 11 is placed in a vacuum chamber, and a lubricant vaporized by heating is introduced in the vacuum chamber to form a film of the lubricant on the stack 11.

In the case where the dip coating or spin coating is used for coating of the second lubricant 122, as a solvent in which the second lubricant is dissolved, a solvent that does not dissolve the first lubricant 121, a solvent that hardly dissolves the first lubricant 121, or a solvent that dissolves the first lubricant 121 but leaves a certain thickness of a film of the first lubricant 121 is used.

The first lubricant 121 constitutes a lubricating layer 12 of the magnetic recording medium 1. Therefore, the film thickness of the first lubricant 121 is preferably from 0.5 nm to 1 nm (5 Å to 10 Å) in view of minimization of abrasion of the surface of the magnetic recording medium 1, improvement of corrosion resistance of the magnetic recording medium 1, and reduction in a distance between a recording head and the magnetic recording medium 1 in a HDD, which leads to a high recording density.

The film thickness of the second lubricant 122 is preferably from 0.5 nm to 2 nm (5 Å to 20 Å). The film of the second lubricant 122 in thickness of from 0.5 nm to 2 nm (5 Å to 20 Å) is suited for burnishing performed on the surface of the stack 11. In addition, the second lubricant 122 can be removed by the UV irradiation 31 or the heat treatment 32 within a short period so that productivity of the magnetic recording medium 1 can be improved.

For the burnishing of the stack 11 with the abrasive material 21, a method where a tape including the abrasive material 21 (burnishing tape) is pressed against the surface of the stack 11 to rub the surface of the stack 11 can be used. A burnishing method and burnishing device will be described in detail with reference to the drawings.

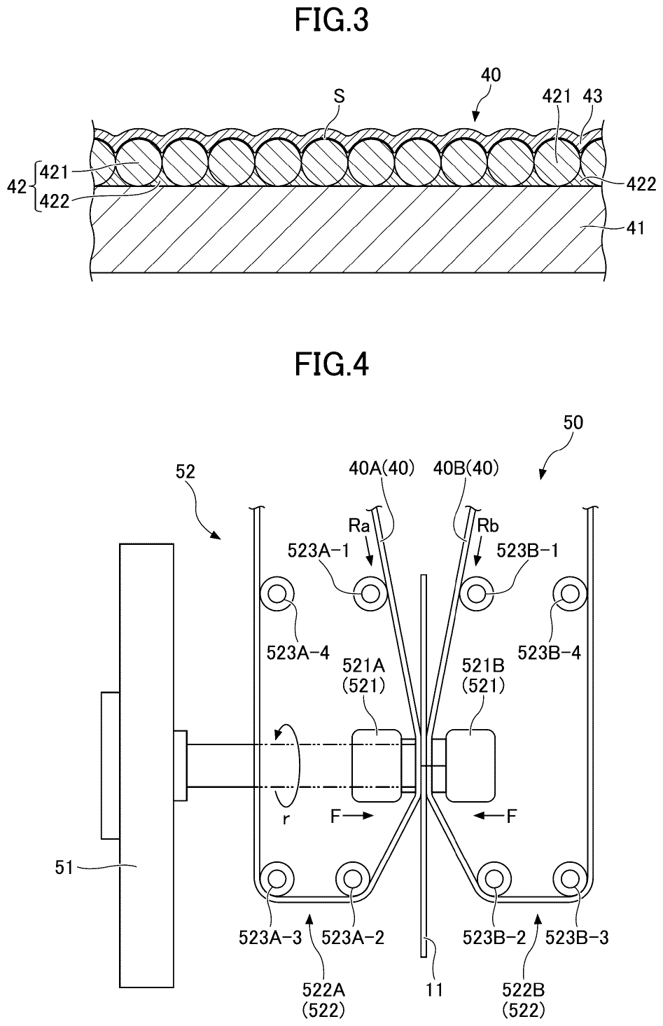

FIG. 3 is an enlarged cross-sectional view illustrating one example of the burnishing tape 40 used for burnishing. As illustrated in FIG. 3, the burnishing tape 40 allows a polishing surface S to slide over the surface of the stack 11, thereby polishing the stack 11.

The burnishing tape 40 includes an abrasive material layer 42 disposed on a support 41. The abrasive material layer 42 includes an abrasive 421 and a binder 422. The binder 422 binds particles of the abrasive 421 together, and binds the abrasive 421 with the support 41 to secure the abrasive 421 within the abrasive material layer 42.

A material constituting the support 41 is not particularly limited, and various resins, such as polyethylene terephthalate and the like, may be used.

The abrasive 421 can be used as the abrasive material 21 included in the burnishing tape 40. Examples of the abrasive 421 include particles including chromium oxide, α-alumina, silicon carbide, non-magnetic iron oxide, diamond, γ-alumina, α,γ-alumina, fused alumina, corundum, artificial diamond, and the like. The abrasive 421 may be particles of any of the above materials. Any of the above materials may be used alone or two or more of the above materials may be used in combination.

The binder 422 is not limited to any particular binder. For example, a thermoset resin, a thermoplastic resin, a photosensitive resin, or the like can be used. As the resin used as the binder 422, a single resin may be used alone, or two or more resins may be used in combination.

Moreover, a lubricating film 43 may be provided on the surface of the polishing surface S.

FIG. 4 is a view illustrating one example of a burnishing device used for burnishing the surface of the stack 11 with the abrasive material 21. As illustrated in FIG. 4, the burnishing device 50 includes a pair of burnishing tapes 40 (burnishing tapes 40A and 40B), which are disposed to face each other with the stack 11 being interposed between the pair of burnishing tapes 40 (burnishing tapes 40A and 40B), a rotating support 51, and a tape moving mechanism 52. In the burnishing device 50, the pair of the burnishing tapes 40 (burnishing tapes 40A and 40B) are disposed to face each other in a manner such that the stack 11 is interposed between the pair of the burnishing tapes 40. Thus, the both sides of the stack 11 can be simultaneously burnished with high efficiency.

The rotating support 51 rotates the stack 11 in a circumferential direction (the direction of the arrow “r”) with an opening formed in a center of the stack 11 being supported by the rotating support 51.

The tape moving mechanism 52 relatively moves the burnishing tapes 40A and 40B in a radius direction of the stack 11, while pressing the burnishing tapes 40A and 40B against the both planes of the rotated stack 11, respectively, in the direction of the arrow “F.”

Moreover, the tape moving mechanism 52 includes a pair of burnishing-tape presses 521 and a pair of burnishing-tape running systems 522. The pair of the burnishing-tape presses 521 and the pair of the burnishing-tape running systems 522 are respectively disposed to face each other via the burnishing tapes 40A and 40B in a manner such that the stack 11 is interposed between the pair of the burnishing-tape presses 521 and between the pair of the burnishing-tape running systems 522.

The pair of the burnishing-tape presses 521 include a first burnishing-tape press 521A and a second burnishing-tape press 521B. The pair of the burnishing-tape running systems 522 include a first burnishing-tape running system 522A and a second burnishing-tape running system 522B.

Specifically, the tape moving mechanism 52 includes the first burnishing-tape running system 522A and the first burnishing-tape press 521A disposed on one side of the stack 11, and the second burnishing-tape running system 522B and the second burnishing-tape press 521B on the other side of the stack 11 with the stack 11 being interposed in between.

The first burnishing-tape running system 522A includes a feeding roll and a take-up roll, which are not illustrated, and first guide rolls 523A-1 to 523A-4 disposed below the feeding roll and the take-up roll. The first burnishing-tape running system allows the burnishing tape 40A to run in the direction of the arrow “Ra.”

The second burnishing-tape running system 522B includes a feeding roll and a take-up roll, which are not illustrated, and second guide rolls 523B-1 to 523B-4 disposed below the feeding roll and the take-up roll. The second burnishing-tape running system 522B allows the burnishing tape 40B to run in the direction of the arrow “Rb.”

In the present disclosure, UV irradiation is performed on the stack 11, or a heat treatment is performed on the stack 11 for removing the second lubricant 122 from the stack 11.

The UV irradiation on the stack 11 can be performed using any irradiation source known in the related art. Examples of the irradiation source include UV lamps, LED lamps, and the like. An emission wavelength, emission output, and irradiation duration of the above lamps are appropriately selected within processing conditions in which the second lubricant 122 can be removed. In addition, processing conditions in which a bonding strength of the first lubricant 121 to the protective layer 113 is increased are preferably considered. Specifically, a peak wavelength of the UV lamp is preferably appropriately selected from 3 ranges, which are a range of 100 nm to 280 nm, a range of 280 nm to 315 nm, and a range of 315 nm to 400 nm. An emission wavelength of the LED lamp is easily controlled. Thus, the LED lamp is preferable, as the LED lamp can be designed according to a lubricant to be used.

The irradiation duration is preferably within one minute in view of productivity of the magnetic recording medium. Thus, the emission output is preferably adjusted so that the processing is completed within one minute.

If UV irradiation is performed in atmospheric air, ozone is generated. The generated ozone may adversely affect production of the magnetic recording medium. Thus, the UV irradiation is preferably performed in an inert gas atmosphere or in a vacuum for minimizing generation of ozone.

The heat treatment may be performed on the stack 11 using any heat source known in the related art. Examples of the heat source include halogen lamp heaters, ceramic heaters, electrical resistance heaters, LED lamp heaters, and the like. A heating temperature and heating duration of the above heat sources are appropriately selected within processing conditions in which the second lubricant 122 can be removed. In addition, processing conditions in which the bonding strength of the first lubricant 121 to the protective layer 113 is increased are preferably also considered.

The heating duration is preferably within 15 minutes in view of productivity of the magnetic recording medium. Thus, the heating duration is preferably adjusted so that the processing is completed within the above period. The heating temperature is preferably 120° C. or lower in view of easiness of design of the heating device. Depending on the heat source, a large amount of gas is released from the heat source by degassing, and the gas generated by the degassing may be incorporated into the stack 11. The incorporated gas may adversely affect production of the magnetic recording medium. Thus, the heat treatment is preferably performed in an inert gas atmosphere.

As described above, the method of producing the magnetic recording medium according to the present embodiment includes the coating step, the burnishing step, and the removing step. In the coating step, the first lubricant applied onto the stack 11 has the mean molecular weight greater than the mean molecular weight of the second lubricant applied onto the first lubricant, and molecules of the first lubricant are more polar than molecules of the second lubricant. The burnishing step includes pressing of the burnishing tape 40 against the surface of the stack 11 to rub the surface of the stack 11. The removing step includes a U irradiation step or a heat treatment step. The UV irradiation step includes irradiating the stack 11, which is coated with the first lubricant 121 and the second lubricant 122, with ultraviolet (UV) rays. The heat treatment step includes performing a heat treatment on the stack 11, which is coated with the first lubricant 121 and the second lubricant 122. The removing step removes the second lubricant 122 by the UV irradiation 31 or the heat treatment 32, and can form the first lubricant 121 as a lubricating layer 12. Thus, coverage of the stack 11 with the lubricating layer 12 can be increased, and an amount of foreign substances generated at the surface of the lubricating layer 12 can be reduced. According to the method of producing the magnetic recording medium according to the present embodiment, foreign substances at the surface of the magnetic recording medium 1 can be efficiently removed, and the magnetic recording medium having high coverage with the lubricating layer 12 can be produced.

As described above, the magnetic recording medium 1 produced in the method of producing the magnetic recording medium according to the present embodiment includes a low amount of foreign substances at the surface of the magnetic recording medium 1 and has high coverage with the lubricating layer 12. Thus, abrasion damage due to sliding contact with a magnetic head can be minimized, and durability can be enhanced. The magnetic recording medium 1 can maintain excellent electromagnetic conversion characteristics, and stably has a high recording density. Therefore, the magnetic recording medium 1 can be suitably used for a magnetic recording and reproducing device. The embodiment of the magnetic recording and reproducing device is not particularly limited, as long as the magnetic recording and reproducing device includes the magnetic recording medium produced by the method of producing the magnetic recording medium according to the present embodiment. The magnetic recording and reproducing device may be a magnetic recording and reproducing device in which magnetic information is recorded on the magnetic recording medium in heat-assisted magnetic recording.

In the present embodiment, the magnetic recording medium may include at least one selected from the group consisting of an adhesion layer, a soft magnetic underlayer, a seed layer, and an orientation control layer disposed between the substrate 111 and the magnetic recording layer 112. One or more of each of the above layers may be disposed.

In the present embodiment, the magnetic recording medium may include two or more magnetic recording layers disposed therein. A non-magnetic recording layer may be disposed between the magnetic recording layers.

The embodiments have been described above, but the embodiments are merely presented as an example, and the present disclosure is not limited to the above embodiments. The above-described embodiments can be implemented in various other forms, and various combinations, omissions, substitutions, changes, and the like can be made without departing from the gist of the invention. Such embodiments and modifications are included in the scope and gist of the invention, and are included in the invention described in the claims and the scope of equivalents thereof.

### EXAMPLES

The present embodiment will be specifically described through examples, but the present embodiment is not limited to these examples.

### Example 1

### [Production of Magnetic Recording Medium]

A pre-washed glass substrate (outer shape: 2.5 inches, available from HOYA) was mounted in a deposition chamber of a DC magnetron sputtering device (C-3040, available from Anelva Corporation), and the deposition chamber was exhausted to the ultimate vacuum of 1×10⁻⁵ Pa. Then, an adhesion layer having a thickness of 10 nm was formed on the glass substrate using a Cr target by sputtering.

Next, a soft magnetic underlayer was formed on the adhesion layer by sputtering. As the soft magnetic underlayer, a first soft magnetic recording layer, an intermediate layer, and a second soft magnetic recording layer were sequentially formed. First, the first soft magnetic recording layer having a thickness of 25 nm was formed using a target of Co-20Fe-5Zr-5Ta {Fe content: 20 at. %, Zr content: 5 at. %, Ta content: 5 at. %, and the remainder: Co} at a substrate temperature of 100° C. or lower. Next, the intermediate layer of Ru having a thickness of 0.7 nm was formed. Thereafter, the second soft magnetic recording layer of Co-20Fe-5Zr-5Ta having a thickness of 25 nm was formed.

Next, a seed layer having a thickness of 5 nm was formed on the soft magnetic underlayer by sputtering using a target of Ni-6W {W content: 6 at. %, and the remainder: Ni}.

Then, as a first orientation control layer, a Ru layer having a thickness of 10 nm was formed on the seed layer by sputtering at a pressure of 0.8 Pa. Next, as a second orientation control layer, a Ru layer having a thickness of 10 nm was formed on the first orientation control layer by sputtering at a pressure of 1.5 Pa.

Subsequently, a first magnetic recording layer of 91 (Co15Cr16Pt)-6(SiO₂)-3(TiO₂) {91 mol % of an alloy having a Cr content of 15 at. %, a Pt content of 16 at. %, and the remainder of Co, 6 mol % of SiO₂, and 3 mol % of TiO₂} was formed on the second orientation control layer by sputtering so that a thickness of the first magnetic recording layer was to be 9 nm. The pressure of the sputtering was set at 2 Pa.

Next, a non-magnetic recording layer of 88 (Co30Cr)-12(TiO₂) {88 mol % of an alloy having a Cr content of 30 at. % and the remainder of Co, and 12 mol % of TiO₂} was formed on the first magnetic recording layer by sputtering so that a thickness of the non-magnetic recording layer was to be 0.3 nm.

Thereafter, a second magnetic recording layer of 92 (Co11Cr18Pt)-5(SiO₂)-3(TiO₂) {92 mol % of an alloy having a Cr content of 11 at. %, a Pt content of 18 at. %, and the remainder of Co, 5 mol % of SiO₂, and 3 mol % of TiO₂} was formed on the non-magnetic recording layer by sputtering so that a thickness of the second magnetic recording layer was to be 6 nm. The pressure of the sputtering was set at 2 Pa.

Thereafter, a non-magnetic recording layer of Ru was formed on the second magnetic recording layer so that a thickness of the non-magnetic recording layer was to be 0.3 nm.

Subsequently, a third magnetic recording layer having a thickness of 7 nm was formed on the non-magnetic recording layer by sputtering using a target of Co-20Cr-14Pt-3B {Cr content: 20 at. %, Pt content: 14 at. %, B content: 3 at. %, and the remainder of Co} at a pressure of 0.6 Pa.

A hydrogenated carbon was formed as a protective layer on the surface of the third magnetic recording layer by ion beam deposition using vaporized toluene as a raw material gas. When the hydrogenated carbon film was formed, a flow rate of the raw material gas fed to a deposition chamber was set at 2.9 SCCM and reaction pressure was set at 0.2 Pa. In addition, a cathode power that was an excitation source of the raw material gas was set at 225 W (AC 22.5 V, 10 A). Then, voltage and current between a cathode electrode and an anode electrode covering the cathode electrode were set at 75 V and 1,650 mA, respectively, ion acceleration voltage and current were set at 200 V and 180 mA, respectively, and film-formation duration was set at 1.5 seconds so that a hydrogenated carbon film having a thickness of 3.5 nm was formed. After forming the hydrogenated carbon film, feeding of the raw material gas was stopped and the film-formation chamber was exhausted for 2 seconds.

Subsequently, a nitrogen gas was fed into the deposition chamber at a flow rate of 2 SCCM and reaction pressure of 5 Pa. Then, cathode power was set at 128 W (AC 16 V, 8 A), voltage and current between a cathode electrode and an anode electrode were set at 75 V and 1,000 mA, respectively, ion-acceleration voltage and current were set at 200 V and 90 mA, respectively, and process duration was set at 1 second, thereby irradiating the surface of the hydrogenated carbon film with nitrogen ions generated from the nitrogen gas to expose to a nitrogen plasma. In the manner as described, the surface of the hydrogenated carbon film was dehydrogenated and nitrided.

Next, D5OH(XS) ((product name, available from MORESCO Corporation)) represented by the following structural formula (i) serving as the first lubricant was dissolved in VERTREL XF (product name, available from Du Pont-Mitsui Fluorochemicals Co., Ltd.), to thereby prepare a first-lubricant-layer forming liquid. The concentration of D5OH(XS) in the first-lubricant-layer forming liquid was 0.3% by mass.

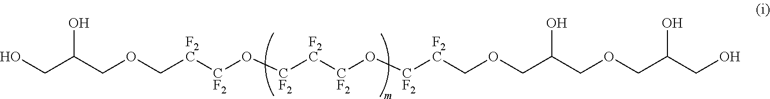

In the structural formula (i) above, m is a positive integer.

Next, the first-lubricant-layer forming liquid was applied onto the protective layer by dip coating. Specifically, the stack of constituent layers including the protective layer defining an exterior surface of the stack was dipped into the first-lubricant-layer forming liquid in an immersion tank of a dip coater, followed by pulling up the stack from the immersion tank at constant speed. In the manner as described, the first-lubricant-layer forming liquid was applied onto the protective layer so that a thickness of a first lubricating layer was to be 0.7 nm (7 Å). Thereafter, the surface of the stack coated with the first-lubricant-layer forming liquid was dried, to thereby form a first lubricating layer on the surface of the stack.

Next, a second lubricant represented by the following structural formula (ii) was dissolved in HFE7200 (product name, available from 3M) to thereby prepare a second-lubricant-layer forming liquid. The concentration of the second lubricant included in the second-lubricant-layer forming liquid was 0.3% by mass. Note that HFE7200 can dissolve the second lubricant represented by the following structural formula (ii), but cannot dissolve the first lubricant D5OH(XS) represented by the structural formula (i).

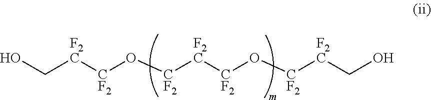

In the structural formula (ii), m is a positive integer.

Next, the second lubricant was applied to the surface of the stack at which the first lubricating layer had been formed by dip coating. The second-lubricant-layer forming liquid was applied so that a thickness of a second lubricating layer was to be 0.7 nm (7 Å). Thereafter, the surface of the stack coated with the second-lubricant-layer forming liquid was dried, to thereby form a second lubricating layer on the surface of the stack at which the first lubricating layer was formed.

Next, the surface of the stack at which the first lubricating layer and the second lubricating layer were formed was subjected to burnishing with a burnishing tape. As the burnishing tape, Model No. DQ3, available from SUMITOMO 3M LIMITED, including Al₂O₃ particles having a particle size of 0.3 μm as an abrasive material was used. As burnishing conditions, the rotational speed of the stack was set at 1,000 rpm, and the processing duration was set at 3 seconds.

Next, UV irradiation was performed on the surface of the stack at which the first lubricating layer and the second lubricating layer were formed. For the UV irradiation, a UV lamp available from Ushio Inc. was used. The UV irradiation was performed in a nitrogen gas atmosphere for the irradiation duration of 10 seconds.

Next, a heat treatment was performed on the surface of the stack at which the first lubricating layer and the second lubricating layer were formed. The heat treatment was performed in a nitrogen gas atmosphere at 120° C. for 1,200 seconds. As the heat treatment was performed on the surface of the stack at which the first lubricating layer and the second lubricating layer were formed, the second lubricating layer was removed from the surface of the first lubricating layer to form a lubricating layer formed of the first lubricating layer. Thus, a magnetic recording medium, in which the adhesion layer, the soft magnetic underlayer, the seed layer, the first orientation control layer, the second orientation control layer, the first magnetic recording layer, the non-magnetic recording layer, the second magnetic recording layer, the non-magnetic recording layer, the third magnetic recording layer, the carbon nitride film (protective layer), and the lubricating layer were disposed on either side of a glass substrate in this order was produced.

### [Evaluation of Lubricating Layer]

The stack after the UV irradiation and the heat treatment was analyzed by ESCA. It was confirmed that the first lubricating layer having a thickness of 0.7 nm (7 Å) remained and the second lubricating layer was removed.

(Coverage with Lubricating Layer)

The coverage of the produced magnetic recording medium with the lubricating layer was measured. The coverage was measured in the following manner. The magnetic recording medium on which the lubricating layer had been formed was immersed in a fluorocarbon solvent for 5 minutes, absorbance at around 1270 cm⁻¹ was measured on an identical position of the same magnetic recording medium before and after the immersion by ESCA, and the coverage was measured as the percentage of the ratio ((absorbance after immersion/absorbance before immersion)×100). As the fluorocarbon solvent, VERTREL XF (product name, available from Du Pont-Mitsui Fluorochemicals Co., Ltd.) was used. The coverage of the produced magnetic recording medium with the lubricating layer was 80%.

### (Thermal Asperity (TA) Glide Test)

A glide test for evaluating thermal asperities (TA) was performed on the produced magnetic recording medium. An MR head was used as an inspection head in the TA glide test. The TA glide test is a method where a phenomenon of changing a signal waveform reproduced by the MR head due to friction heat generated when the MR head collides with projected portions at a surface of the magnetic recording medium, i.e., thermal asperities (TA), is detected, and smoothness of the magnetic recording medium is evaluated from the occurrence number (TA count) of the signal. The smaller the TA count is, the higher the smoothness of the surface of the magnetic recording medium is. The average of the TA counts measured on one hundred recording media produced was 7 per surface.

The processing conditions of the second lubricant and evaluation results of the lubricating layer in Example 1 are presented in Table 1.

### Examples 2 to 11 and Comparative Examples 1 to 4

A magnetic recording medium was produced and evaluated in the same manner as in Example 1, except that the preparation conditions of the first lubricant and the second lubricant and the processing condition of the second lubricant were changed to the numerical values presented in Table 1. The production conditions and evaluation results are presented in Table 1. Note that D4OH and D4OH(s) (both product names, available from MORESCO Corporation) used as the first lubricant in Examples 3 and 4, and D4OH(s) (product names, available from MORESCO Corporation) used as the second lubricant in Comparative Example 3 are represented by the following chemical formula (iii). The structural formula (iv) is as presented below. The mean molecular weight of D4OH was adjusted to be 2,000, and the mean molecular weight of D4OH(s) was adjusted to be 1,600.

CH₂(OH)CH(OH)CH₂OCH₂CF₂CF₂(OCF₂CF₂CF₂)ₘOCF₂CF₂CH₂OCH₂CH(OH)CH₂OH Chemical formula (iii) of D4OH and D4OH(s):

In the above chemical formula (iii), m is a positive integer.

### Structural Formula (iv):

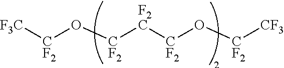

In Comparative Example 5, UV irradiation and a heat treatment (a dry process) were not performed, but washing using a solvent (a wet process) was performed for removal of the second lubricant. As the solvent, HFE7200 was used. As the washing, spin washing was performed.

TABLE 1

| | Production conditions of first lubricant layer and second lubricant layer | | | | | | | |
|---|---|---|---|---|---|---|---|---|
| | First lubricating layer | | | | Second lubricating layer | | | |
| | First lubricant | | | | Second lubricant | | | |
| | | | No. of | Thickness | | | No. of | Thickness |
| | Type | Mean Mw | polar groups | [Å] | Type | Mean Mw | OH groups | [Å] |
| Ex. 1 | D5OH(XS) | 1300 | 5 | 7 | Formula (ii) | 600 | 2 | 7 |
| Ex. 2 | D5OH(XS) | 1300 | 5 | 7 | Formula (iv) | 600 | 0 | 7 |
| Ex. 3 | D4OH(s) | 1600 | 4 | 7 | Formula (iv) | 600 | 0 | 7 |
| Ex. 4 | D4OH | 2000 | 4 | 7 | Formula (iv) | 600 | 0 | 7 |
| Ex. 5 | D5OH(XS) | 1300 | 5 | 5 | Formula (iv) | 600 | 0 | 7 |
| Ex. 6 | D5OH(XS) | 1300 | 5 | 10 | Formula (iv) | 600 | 0 | 7 |
| Ex. 7 | D5OH(XS) | 1300 | 5 | 7 | Formula (iv) | 600 | 0 | 2 |
| Ex. 8 | D5OH(XS) | 1300 | 5 | 7 | Formula (iv) | 600 | 0 | 20 |
| Ex. 9 | D5OH(XS) | 1300 | 5 | 7 | Formula (iv) | 600 | 0 | 7 |
| Ex. 10 | D5OH(XS) | 1300 | 5 | 7 | Formula (iv) | 600 | 0 | 7 |
| Ex. 11 | D5OH(XS) | 1300 | 5 | 7 | Formula (ii) | 600 | 2 | 7 |
| Comp. Ex. 1 | D5OH(XS) | 1300 | 5 | 7 | — | — | — | — |
| Comp. Ex. 2 | D5OH(XS) | 1300 | 5 | 7 | D5OH(XS) | 1300 | 5 | 7 |
| Comp. Ex. 3 | D5OH(XS) | 1300 | 5 | 7 | D4OH(s) | 1600 | 4 | 7 |
| Comp. Ex. 4 | D5OH(XS) | 1300 | 5 | 7 | Formula (iv) | 600 | 0 | 7 |

In Table 1, “Mean Mw” denotes a mean molecular weight; Formula (ii) denotes Structural formula (ii); and Formula (iv) denotes Structural formula (iv).

TABLE 2

| | Processing conditions of first lubricating | | | | | | |
|---|---|---|---|---|---|---|---|
| | layer and second lubricating layer | | | | Evaluation results of lubricating layers | | |
| | UV irradiation | | Heat treatment | | Evaluation of lubricating layers | Coverage rate | TA count |
| | Irradiation | Time | Temp. | Time | first lubricating layer/second | with lubricating | (number/ |
| | source | [s] | [° C.] | [s] | lubricating layer | layer [%] | plane) |
| Ex. 1 | UV lamp | 10 | 120 | 1200 | Remaining/removed | 80 | 7 |
| Ex. 2 | UV lamp | 10 | 120 | 1200 | Remaining/removed | 80 | 5 |
| Ex. 3 | UV lamp | 10 | 120 | 1200 | Remaining/removed | 78 | 5 |
| Ex. 4 | UV lamp | 10 | 120 | 1200 | Remaining/removed | 78 | 7 |
| Ex. 5 | UV lamp | 10 | 120 | 1200 | Remaining/removed | 74 | 10 |
| Ex. 6 | UV lamp | 10 | 120 | 1200 | Remaining/removed | 85 | 5 |
| Ex. 7 | UV lamp | 10 | 120 | 1000 | Remaining/removed | 80 | 10 |
| Ex. 8 | UV lamp | 10 | 120 | 1800 | Remaining/removed | 80 | 5 |
| Ex. 9 | UV lamp | 15 | — | — | Remaining/removed | 80 | 6 |
| Ex. 10 | — | — | 120 | 1800 | Remaining/removed | 80 | 8 |
| Ex. 11 | UV lamp | 5 | 120 | 60 | Remaining/partially remaining | 83 | 15 |
| Comp. Ex. 1 | UV lamp | 10 | 120 | 1200 | Remaining/— | 80 | 100 |
| Comp. Ex. 2 | UV lamp | 10 | 120 | 1200 | Remaining/remaining | 85 | 16 |
| Comp. Ex. 3 | UV lamp | 10 | 120 | 1200 | Remaining/remaining | 86 | 20 |
| Comp. Ex. 4 | — | — | — | — | Remaining/removed | 80 | 50 |

According to Tables 1 and 2, the coverage with the lubricating layer was 74% or greater, and the TA count was 10 or greater in each of Examples. On the other hand, the TA count was 15 or greater in each of Comparative Examples. Accordingly, when the second lubricant was removed by irradiation of UV rays or the heat treatment to form the lubricating layer by the method of producing the magnetic recording medium of the present embodiment, foreign substances at the surface of the magnetic recording medium could be efficiently removed, and the magnetic recording medium having high coverage with the lubricating layer could be obtained.

According to one aspect of the present disclosure, foreign substance on a surface of a magnetic recording medium can be efficiently removed, and coverage with the lubricating layer can be increased.

For example, the present disclosure includes the following configurations.

[1] A method of producing a magnetic recording medium in which a lubricating layer is formed on a stack including a magnetic recording layer and a protective layer disposed on a substrate in an order as mentioned. The method includes: coating the stack with a first lubricant and a second lubricant; burnishing a surface of the stack, which is coated with the first lubricant and the second lubricant, with an abrasive material; and removing the second lubricant present on the stack. The first lubricant has a mean molecular weight greater than a mean molecular weight of the second lubricant. Molecules of the first lubricant are more polar than molecules of the second lubricant. The burnishing includes pressing a tape including the abrasive material against the surface of the stack to rub the surface of the stack. The removing of the second lubricant includes irradiating the stack, which is coated with the first lubricant and the second lubricant, with ultraviolet rays, or performing a heat treatment on the stack, which is coated with the first lubricant and the second lubricant.
[2] The method described in [1], in which the second lubricant has the mean molecular weight of from 300 to 1,000, and includes two or less polar groups or no polar group.
[3] The method described in [1] or [2], in which the first lubricant has the mean molecular weight of from 900 to 3,000, and includes 4 to 8 polar groups.
[4] The method described in any one of [1] to [3], in which the first lubricant coated on the stack has a film thickness of from 0.5 nm to 1 nm, and the second lubricant has a film thickness of from 0.5 nm to 2 nm.
[5] The method described in any one of [1] to [4], in which the irradiating with the ultraviolet rays is performed in an inert gas atmosphere or in a vacuum.
[6] The method described in any one of [1] to [5], in which the heat treatment is performed in an inert gas atmosphere.

What is claimed is:

1. A method of producing a magnetic recording medium in which a lubricating layer is formed on a stack including a magnetic recording layer and a protective layer disposed on a substrate in an order as mentioned, the method comprising:
coating the stack with a first lubricant and a second lubricant;
burnishing a surface of the stack, which is coated with the first lubricant and the second lubricant, with an abrasive material; and
removing the second lubricant present on the stack,
wherein the first lubricant has a mean molecular weight greater than a mean molecular weight of the second lubricant,
wherein molecules of the first lubricant are more polar than molecules of the second lubricant,
wherein the burnishing includes pressing a tape including the abrasive material against the surface of the stack to rub the surface of the stack, and
wherein the removing of the second lubricant includes irradiating the stack, which is coated with the first lubricant and the second lubricant, with ultraviolet rays, or performing a heat treatment on the stack, which is coated with the first lubricant and the second lubricant.

2. The method according to claim 1,
wherein the second lubricant has the mean molecular weight of from 300 to 1,000, and includes two or less polar groups or no polar group.

3. The method according to claim 1,
wherein the first lubricant has the mean molecular weight of from 900 to 3,000, and includes 4 to 8 polar groups.

4. The method according to claim 1,
wherein the first lubricant coated on the stack has a film thickness of from 0.5 nm to 1 nm, and the second lubricant has a film thickness of from 0.5 nm to 2 nm.

5. The method according to claim 1,
wherein the irradiating with the ultraviolet rays is performed in an inert gas atmosphere or in a vacuum.

6. The method according to claim 1,
wherein the heat treatment is performed in an inert gas atmosphere.

7. The method according to claim 2,
wherein the first lubricant has the mean molecular weight of from 900 to 3,000, and includes 4 to 8 polar groups.

8. The method according to claim 2,
wherein the first lubricant coated on the stack has a film thickness of from 0.5 nm to 1 nm, and the second lubricant has a film thickness of from 0.5 nm to 2 nm.

9. The method according to claim 2,
wherein the irradiating with the ultraviolet rays is performed in an inert gas atmosphere or in a vacuum.

10. The method according to claim 2,
wherein the heat treatment is performed in an inert gas atmosphere.
